(19) United States
(12) Patent Application Publication
(10) Pub. No.: US 2026/0349812 A1
(43) Pub. Date: Nov. 5, 2026

(54) MACHINE LEARNING SYSTEMS FOR SCHEDULING A TASK TO BE PERFORMED WITHIN A RESOURCE CONSTRAINT

(71) Applicant: Truist Bank, Charlotte, NC (US)

(72) Inventors: Sweta Sharan, Cumming, GA (US); Narayan Kapil, Winston-Salem, NC (US)

(73) Assignee: Truist Bank, Charlotte, NC (US)

(21) Appl. No.: 19/197,816

(22) Filed: May 2, 2025

Related U.S. Application Data
(63) Continuation of application No. 19/196,837, filed on May 2, 2025.

(51) Int. Cl. G06F 9/50; G06N 20/00

(52) U.S. Cl. CPC G06F 9/5027; G06N 20/00

(57) ABSTRACT

In some examples, a system can use machine learning to schedule one or more tasks to be performed within a resource constraint. The system can train a machine-learning model based on training data that can include historical execution data for historical tasks performed by one or more entities. The system can receive a request including the tasks and can generate input data based on the request. The system can provide the input data to the trained machine-learning model, thereby obtaining an output indicating a respective execution outcome of each entity with respect to performing at least one task. Based on the output, the system can determine that the entities are unable to individually perform at least one task within the resource constraint. The system can perform an action to resolve the inability of the entities to perform the at least one task within the resource constraint.

### CROSS-REFERENCE TO RELATED APPLICATION

The present application is a continuation of U.S. application Ser. No. 19/196,837, filed May 2, 2025, titled “MACHINE LEARNING SYSTEMS FOR SCHEDULING A TASK TO BE PERFORMED WITHIN A RESOURCE CONSTRAINT,” the entirety of which is incorporated herein by reference.

### TECHNICAL FIELD

The present disclosure relates generally to artificial intelligence and, more particularly (although not necessarily exclusively), machine learning systems for scheduling a task to be performed within a resource constraint.

### BACKGROUND

A request can include one or more tasks to be executed by one or more processors of a computing system. A resource constraint can complicate the execution of the tasks by limiting an amount of resources allowed to perform the tasks. The computing system can employ a task scheduler to schedule the tasks of the request such that the processors can perform the tasks as individuals or in combination. For instance, the task scheduler can schedule the tasks such that the tasks can be executed in parallel by more than one processor to share a workload of the request. Additionally, the task scheduler can allocate system resources to enable the processors to share the system resources effectively.

### SUMMARY

One example of the present disclosure includes a system having one or more processors and a memory that includes instructions executable by the one or more processors for causing the one or more processors to perform operations. The operations can include accessing training data that includes historical execution data associated with one or more historical tasks performed by one or more entities. The historical execution data can indicate one or more relationships between the one or more entities and one or more historical execution outcomes of the one or more historical tasks. The operations can include training a machine-learning model based on the training data to generate a trained machine-learning model. Training the machine-learning model can involve performing iterative adjustments of parameters of the machine-learning model to minimize a loss function associated with the machine-learning model. The operations can include receiving a request including one or more tasks that are each schedulable to be performed by the one or more entities. The operations can include generating input data based on the request. The input data can indicate the one or more tasks and can include a resource constraint related to completing the one or more tasks. The operations can include providing the input data to the trained machine-learning model configured to generate an output indicating a respective execution outcome corresponding to each entity of the one or more entities with respect to performing at least one task of the one or more tasks. The operations can include determining, based on the output of the trained machine-learning model, that the one or more entities are unable to individually perform at least one task of the one or more tasks within the resource constraint. The operations can include performing an action to resolve the inability of the one or more entities to individually perform the at least one task within the resource constraint.

Another example of the present disclosure includes a computer-implemented method of operations. The operations can include accessing training data that includes historical execution data associated with one or more historical tasks performed by one or more entities. The historical execution data can indicate one or more relationships between the one or more entities and one or more historical execution outcomes of the one or more historical tasks. The operations can include training a machine-learning model based on the training data to generate a trained machine-learning model. Training the machine-learning model can involve performing iterative adjustments of parameters of the machine-learning model to minimize a loss function associated with the machine-learning model. The operations can include receiving a request including one or more tasks that are each schedulable to be performed by the one or more entities. The operations can include generating input data based on the request. The input data can indicate the one or more tasks and can include a resource constraint related to completing the one or more tasks. The operations can include providing the input data to the trained machine-learning model configured to generate an output indicating a respective execution outcome corresponding to each entity of the one or more entities with respect to performing at least one task of the one or more tasks. The operations can include determining, based on the output of the trained machine-learning model, that the one or more entities are unable to individually perform at least one task of the one or more tasks within the resource constraint. The operations can include performing an action to resolve the inability of the one or more entities to individually perform the at least one task within the resource constraint.

Yet another example of the present disclosure includes a non-transitory computer-readable medium including program code that is executable by one or more processors for causing the one or more processors to perform one or more operations. The operations can include accessing training data that includes historical execution data associated with one or more historical tasks performed by one or more entities. The historical execution data can indicate one or more relationships between the one or more entities and one or more historical execution outcomes of the one or more historical tasks. The operations can include training a machine-learning model based on the training data to generate a trained machine-learning model. Training the machine-learning model can involve performing iterative adjustments of parameters of the machine-learning model to minimize a loss function associated with the machine-learning model. The operations can include receiving a request including one or more tasks that are each schedulable to be performed by the one or more entities. The operations can include generating input data based on the request. The input data can indicate the one or more tasks and can include a resource constraint related to completing the one or more tasks. The operations can include providing the input data to the trained machine-learning model configured to generate an output indicating a respective execution outcome corresponding to each entity of the one or more entities with respect to performing at least one task of the one or more tasks. The operations can include determining, based on the output of the trained machine-learning model, that the one or more entities are unable to individually perform at least one task of the one or more tasks within the resource constraint. The operations can include performing an action to resolve the inability of the one or more entities to individually perform the at least one task within the resource constraint.

### BRIEF DESCRIPTION OF THE DRAWINGS

FIG. 1 is a block diagram of an example of a system including a trained machine-learning model used to select at least one target entity to perform a task of a request, according to some aspects of the present disclosure.

FIG. 2 is a block diagram of an example of a model training application that can train a machine-learning model to generate the trained machine-learning model of FIG. 1, according to some aspects of the present disclosure.

FIG. 3 is a block diagram of an example of inputs and outputs corresponding to a trained machine-learning model that can select at least one target entity to perform a task of a request, according to some aspects of the present disclosure.

FIG. 4 is a block diagram of an example of a computing system usable for scheduling a task to be performed within a resource constraint, according to some aspects of the present disclosure.

FIG. 5 is a flow chart of an example of a process for providing input data including a resource constraint to a trained machine-learning model to schedule a task to be performed by a target entity, according to some aspects of the present disclosure.

### DETAILED DESCRIPTION

Certain aspects and examples of the present disclosure relate to using machine learning to schedule a task of a request to be performed within a resource constraint. A system can include one or more entities that can perform one or more tasks of the request. Each entity typically has a limited capacity for handling tasks. Additionally, the system may have limited system resources that can be used to perform the tasks of the request. In some cases, each entity associated with the system may be unaware of its respective capacity or efficiency. For instance, a particular entity may be unable to accurately predict the amount of resources that it will consume to complete a particular task of the request. As a result, scheduling the tasks of the request to be executed by the entities can be difficult. For instance, if the system underestimates the resource consumption of the entities, the system may schedule fewer tasks to be performed by the entities than the entities can handle, increasing response time to perform the request. On the other hand, if the system overestimates the resource consumption of the entities, the entities may be overwhelmed or lack sufficient system resources to execute the tasks of the request.

Some examples described herein can address one or more of the abovementioned problems using a trained machine-learning model to help identify a target entity that can perform a task of a request within a resource constraint. The request can include one or more tasks that can correspond to subcomponents of the request such that completing the request can involve executing all of the tasks. The machine-learning model can be trained to determine or predict which entity or entities currently have or will have (in the future) sufficient capacity to perform the task, so that the tasks of the request can be efficiently scheduled among entities. Efficiently allocating tasks among the entities can improve resource allocation of the system resources.

More specifically, in some examples the system can apply workload automation techniques to schedule of the tasks, ensuring that the tasks can be performed within the resource constraint. For instance, the system can apply the trained machine-learning model to input data, including the resource constraint. Based on the input data, the trained machine-learning model can generate an output indicating a target entity of one or more entities. The target entity may be selected by the trained machine-learning model for its ability to execute the task within the resource constraint. In some cases, the trained machine-learning model can output multiple entities based on the input data, which may signify that multiple entities alone or in combination have the ability to handle a given task. The system may schedule the task to some or all of the selected entities. Additionally or alternatively, the trained machine-learning model may output one or more entities that are unable to perform the task within the resource constraint, either as individuals or in combination. This may help the system avoid scheduling the task to unsuitable entities.

In some examples, the system can generate the trained machine-learning model by training a machine-learning model using historical performance of the entities with respect to performing historical tasks. The historical performance of the entities can include relationships between attributes of the entities and a respective amount of historical execution time taken to perform the historical tasks. The system can iteratively supply training data including the historical performance of the entities to the machine-learning model to train the machine-learning model. As part of the training, the machine-learning model can identify the relationships provided in the historical execution data and extrapolate the relationships to unseen input. Once trained, the machine-learning model may be able to accurately predict which entities have the capability to perform which tasks based on their current workload and historical performance of the same or similar tasks.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

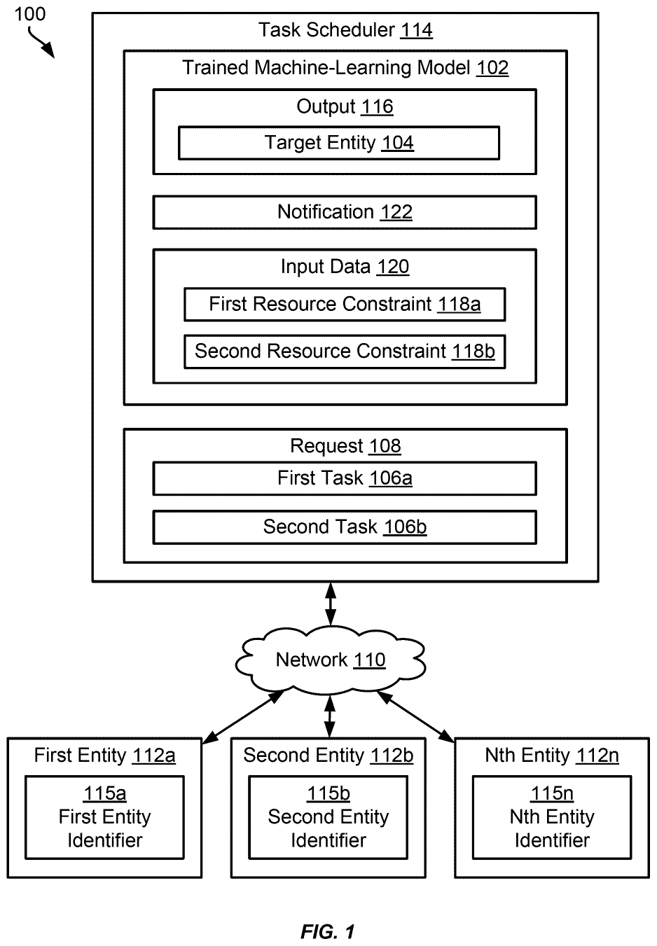

FIG. 1 is a block diagram of an example of a system 100 including a trained machine-learning model 102 used to select at least one target entity 104 to perform a task 106 of a request 108, according to some aspects of the present disclosure. In some examples, a user of the system 100 may generate the request 108 including the task 106 such that a task scheduler 114 of the system 100 can determine the target entity 104 to execute the task 106. The task 106 of the request 108 can include threads, processes, or workflows.

Components within the system 100 may be communicatively coupled via a wireless connection (e.g., a network 110, IEEE 802.11, Bluetooth, or radio interfaces for accessing cellular telephone networks). Examples of the network 110 can include a local area network (LAN), wide area network (WAN), the Internet, or a combination of these. For example, the system 100 can include one or more entities 112a-n (e.g., a first entity 112a and a second entity 112b) that can be communicatively coupled to the task scheduler 114 of the system 100 via the network 110. Examples of the system 100 can include a desktop computer, laptop computer, server, mobile phone, or tablet. Examples of the entities 112a-n can include servers, processors, developers, or other suitable entities that can perform operations to perform the task 106 of the request 108. Each entity of the entities 112a-n can be associated with a respective entity identifier (e.g., a first entity identifier 115a and a second entity identifier 115b) used to identify or distinguish each entity.

In some examples, the task scheduler 114 can include the trained machine-learning model 102. The task scheduler 114 may be a computer program that is executable by a processor. The trained machine-learning model 102 may be a module of the task scheduler 114. The trained machine-learning model 102 can receive input data 120 from the task scheduler 114 to generate an output 116 indicating the target entity 104 of the entities 112a-n. The input data 120 can include one or more resource constraints 118, information about a target task, and data about the current workloads of candidate entities. Based on the input data 120, the trained machine-learning model 102 can select the target entity 104 based on the target entity's 104 ability to perform the task 106 within the resource constraints 118 (e.g., a first resource constraint 118a or a second resource constraint 118b). The trained machine-learning model 102 can provide an output 116 indicating the selected target entity 104.

In some cases, the resource constraint 118 may include a maximum amount of time in which the task is to be completed or a deadline by which the task is to be completed. Additionally or alternatively, the resource constraint 118 may include a maximum threshold with respect to certain metrics, such as wait time, latency, or vulnerabilities. For example, the resource constraint 118 may be a maximum response time. In this example, the target entity 104 can be selected by the trained machine-learning model 102 based on the target entity's 104 ability to perform the task 106 with a response time that is below the maximum threshold. In some examples, the resource constraint 118 can include a minimum threshold with respect to certain metrics, such as throughput.

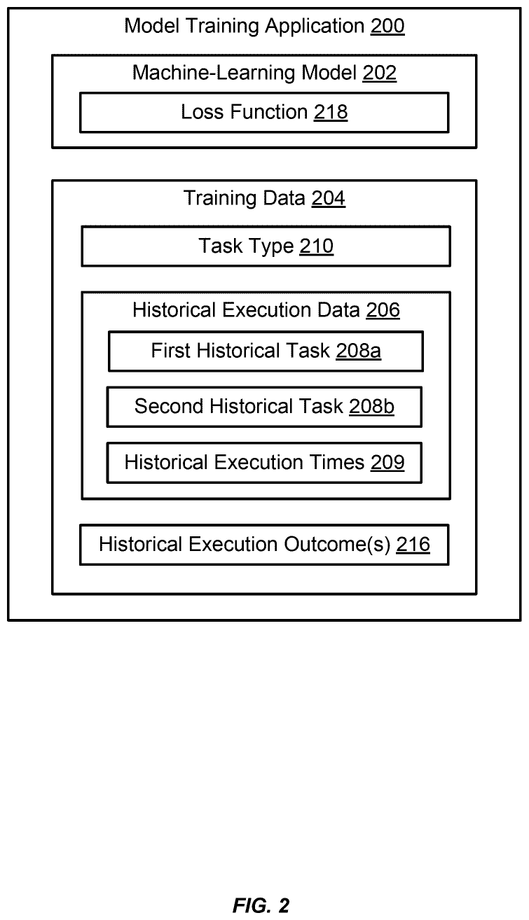

The trained machine-learning model 102 can be trained through a training process that can involve iteratively supplying training data to a machine-learning model to enable the machine-learning model to identify patterns related to the training data. Additionally or alternatively, training the machine-learning model can involve providing the training data to the machine-learning model 102 to enable the machine-learning model to identify relationships between the training data and output data. More details about the training process are described below with respect to FIG. 2.

Once the trained machine-learning model 102 is available, the task scheduler 114 can provide input data 120 to the trained machine-learning model 102 to determine the target entity 104 to perform the task 106 of the request 108. In some cases, the task scheduler 114 may generate the input data 120 based on components or data provided in the request 108. The input data 120 can indicate the tasks 106a-b that can be scheduled by the task scheduler 114 to be executed by the entities 112a-n. Additionally, the input data 120 can include the resource constraint 118 associated with the request 108.

In some examples, the input data 120 can provide data associated with the tasks 106a-b of the request 108. For example, the input data 120 may include a respective task description corresponding to each task provided in the input data 120. The task description may provide data that can facilitate task scheduling implemented by the task scheduler 114 by indicating parameters associated with the corresponding task. For example, the task description may indicate a priority of the corresponding task. As another example, the task description can indicate whether the corresponding task is associated with (e.g., depends on) another task of the request 108. If the first task 106a of the request 108 has a task dependency associated with the second task 106b of the request 108, the task scheduler 114 may schedule the first task 106a after the second task 106b is successfully executed.

Additionally or alternatively, the input data 120 can include data associated with the entities 112a-n. For example, the input data 120 can indicate a respective workload of the entities 112a-n. The workloads of the entities 112a-n can correspond to a current number of tasks scheduled to be performed by a particular entity of the entities 112a-n. As another example, the input data 120 can indicate a respective capacity of the entities 112a-n, such as a maximum number of simultaneous tasks that each entity can perform. In some cases, the task scheduler 114 can manage a respective queue of the entities 112a-n that indicates a respective set of scheduled tasks to be executed by each entity, enabling the task scheduler 114 to remain aware of the workloads of the entities 112a-n.

In some examples, the input data 120 can include data corresponding to variables used to generate the trained machine-learning model 102, enabling the trained machine-learning model 102 to determine a respective execution outcome (e.g., execution times) of the entities 112a-n. The target entity 104 can be determined based on the execution outcomes of the entities 112a-n. Based on the input data 120, the trained machine-learning model 102 can generate the output 116 indicating the target entity 104 of the entities 112a-n. The trained machine-learning model 102 can use the input data 120 to assess a respective capacity or the respective execution outcome of each entity to select an individual entity of the entities 112a-n as the target entity 104. For example, the trained machine-learning model 102 can apply recognition patterns developed during training to the input data 120 to determine a respective execution time for each of the entities 112a-n.

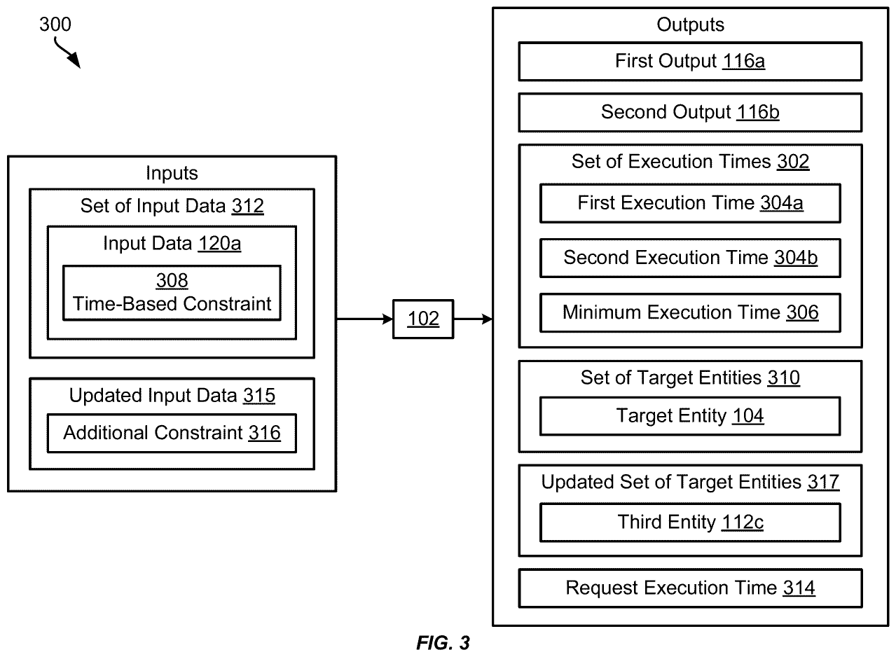

Additionally or alternatively, the trained machine-learning model 102 may generate a set of target entities as the output 116. For example, based on the input data 120, the trained machine-learning model 102 may determine that current capacities of the entities 112a-n are insufficient to execute the task 106 as individuals. As a result, the trained machine-learning model 102 can output the set of target entities to cooperate with each other and collectively perform the task 106. For example, if the set of target entities are CPU cores, a first target entity may perform a first subtask of the task 106 as a second target entity performs a second subtask of the task 106 such that both target entities can make progress with the task 106. Additional details regarding the set of target entities are provided below with respect to FIG. 3.

In some examples, the trained machine-learning model 102 may determine that the entities 112a-n associated with the system 100 are unable to perform a certain task (e.g., the second task 106b) within the resource constraint 118. For example, the entities 112a-n may lack sufficient resources to execute the second task 106b within the resource constraint 118 as individuals or in combination. In some cases, the input data 120 provided by the task scheduler 114 to the trained machine-learning model 102 can include more than one resource constraint associated with the request 108. For example, the input data 120 provided to the trained machine-learning model 102 may include a first resource constraint 118a corresponding to the first task 106a and a second resource constraint 118b corresponding to the second task 106b. Based on the second resource constraint 118b, the trained machine-learning model 102 can determine that the entities 112a-n are unable to perform the second task 106b within the second resource constraint 118b. For example, the output 116 of the trained machine-learning model 102 may indicate an inability of the entities 112a-n to perform the second task 106b within the second resource constraint 118b as individuals or in combination.

The trained machine-learning model then can output a notification 122 to indicate the inability of the entities 112a-n to perform the second task 106b within the second resource constraint 118b. In some examples, the task scheduler 114 may receive the notification 122 from the trained machine-learning model 102. After receiving the notification 122, the task scheduler 114 can perform one or more actions to mitigate or resolve the inability of the entities 112a-n to perform the second task 106b within the second resource constraint 118b. For example, the task scheduler 114 can reallocate the system resources of the system 100 to accommodate the second task 106b. As another example, the task scheduler 114 may reschedule existing tasks of the entities 112a-n that are incomplete to enable the entities 112a-n to perform the second task 106b within the second resource constraint 118b.

In some cases, the task scheduler 114 can reschedule the existing tasks of the entities 112a-n based on a scheduling scheme (e.g., a scheduling algorithm) associated with the tasks 106a-b and the existing tasks. The task scheduler 114 can apply the scheduling scheme when a scheduling event occurs, such as after a particular task is executed or when an additional task is received. For instance, when scheduling the second task 106b, the task scheduler 114 can apply priority scheduling to determine whether the second task 106b has a higher priority than the existing tasks scheduled to be performed by the entities 112a-n. In some examples, if the second task 106b is prioritized over the existing tasks, the task scheduler 114 can reschedule the existing tasks that are incomplete such that the entities 112a-n can perform the second task 106b before performing the existing tasks.

FIG. 2 is a block diagram of an example of a model training application 200 that can train a machine-learning model 202 to generate the trained machine-learning model 102 of FIG. 1, according to some aspects of the present disclosure. For example, the model training application 200 to train a machine-learning model 202 to thereby generate the trained machine-learning model 102 of FIG. 1. In some examples, the model training application 200 can be part of the system 100 of FIG. 1. In other examples, the model training application 200 may be separate and remote from the system (e.g., the model training application 200 may be deployed on a model training server that can be communicatively coupled to the system 100). The trained machine-learning model 102 can be accessible by a task scheduler 114 of the system 100 after the model training application 200 trains the machine-learning model 202. Aspects of FIG. 2 are described below with reference to components of FIG. 1.

The machine-learning model 202 can be trained based on training data 204. In some examples, training data 204 can be stored in a data repository that can be accessible by the model training application 200. The training data 204 can include historical execution data 206 associated with one or more historical tasks 208a-b previously performed by the entities 112a-n. For example, the historical execution data 206 can indicate how long it historically took the entities 112a-n to perform different kinds of tasks in the past, along with their other workloads at those times and any other factors that may have contributed to their performance. The training data 204 can be organized by different attributes, such as by task type 210, by entity, entity role, or in any other suitable manner for training purposes. Organizing the training data 204 can involve labeling individual subsets of the training data 204 based on a respective attribute of each subset of the training data 204. For example, the training data 204 may include one or more tags or other suitable identifiers that can be used to determine a respective dataset of the training data 204 that corresponds to each entity of the entities 112a-n. If the training data 204 is organized by entity, a respective entity identifier (e.g., a first entity identifier 115a and a second entity identifier 115b) can be used to identify a respective subset of the historical tasks 208a-b corresponding to each entity. In particular, the model training application 200 may use the respective entity identifiers to determine respective historical execution data of the historical tasks 208a-b performed by each entity of the entities 112a-n. As another example, the training data 204 may include a respective dataset corresponding to a task type 210 that can be used to categorize the task 106 of the request 108. In some implementations, the task type 210 can correspond to configuring settings, debugging code, building code, testing code, or deploying code.

The historical execution data 206 can indicate one or more relationships between the entities 112a-n and one or more historical execution outcomes 216 of the entities 112a-n with respect to the historical tasks 208a-b of the historical execution data 206. For example, the historical execution data 206 may indicate a pattern of the first entity 112a historically having faster execution times than the second entity 112b when executing certain tasks. In some cases, variables that can affect the relationships between the entities 112a-n and the historical execution data 206 can correspond to the different attributes (e.g., entity, task type 210, entity role, etc.) used to organize the training data 204. The machine-learning model 202 can be trained to recognize and extrapolate the relationships provided in the training data 204 such that the trained machine-learning model 102 can determine the target entity 104 based on the input data 120. In some examples, each entity of the entities 112a-n can perform a functionality, such as with respect to a respective entity role of the entities 112a-n. For example, if the entities 112a-n are processors, the system 100 can include a graphics processing unit (GPU) to perform graphics-related functionalities and a floating-point unit (FPU) to perform floating-point arithmetic functionalities. As another example, a first entity 112a may function as a back-end developer, while a second entity 112b may function as a front-end developer.

Training the machine-learning model 202 can involve performing iterative adjustments of parameters of the machine-learning model 202 to minimize a loss function 218 of the machine-learning model 202. The loss function 218 can be defined based on the variables that can affect the relationships between the entities 112a-n and the historical execution data 206. In some examples, the parameters of the machine-learning model 202 can include architectural parameters (e.g., hyperparameters) of the machine-learning model 202 that remain unaltered when minimizing the loss function 218 of the machine-learning model 202 during training. For example, if the machine-learning model 202 is a neural network, the architectural parameters can include a quantity of layers in the neural network, a quantity of nodes in each layer of the neural network, etc.

Additionally, the parameters of the machine-learning model 202 can include adjustable parameters that are calibrated by fitting the training data 204 to the machine-learning model 202. For example, an adjustable parameter of the neural network can include a respective weight of connections between the nodes of the neural network. The adjustable parameters can be modified during training when minimizing the loss function 218. In some examples, the model training application 200 can retrain or further train the trained machine-learning model 202 over time to improve an accuracy or functionalities of the trained machine-learning model 102. For example, the system 100 of FIG. 1 may generate one or more logs (e.g., event logs, transaction logs, server logs, etc.) that can provide information associated with operations associated with the system 100. In some cases, the model training application 200 can collect the information from the logs of the system 100 to update the training data 204 used to construct the trained machine-learning model 102. The model training application 200 then can use the updated training data to update the trained machine-learning model 102.

For example, FIG. 3 is a block diagram 300 of an example of inputs and outputs corresponding to a trained machine-learning model 102 that can select at least one target entity 104 to perform a task 106 of a request 108, according to some aspects of the present disclosure. Aspects of FIG. 3 are described below with reference to components of FIGS. 1-2. The trained machine-learning model 102 can generate a set of execution times 302 based on the input data 120. The set of execution times 302 can include a respective execution time for each entity of the entities 112a-n to perform the task 106. For example, a first execution time 304a of the set of execution times 302 can correspond to a first execution outcome of the first entity 112a by indicating an amount of time that the first entity 112a may take to execute the task 106. Similarly, a second execution time 304b of the set of execution times 302 can correspond to a second execution outcome of the second entity 112b by indicating another amount of time that the second entity 112b may take to execute the task 106. Accordingly, the execution times 304a-b of the entities 112a-n can correspond a respective execution outcome of the entities 112a-n with respect to performing the task 106.

In some examples, the task scheduler 114 may identify a minimum execution time 306 from the set of execution times 302 generated by the trained machine-learning model 102. For example, if the first execution time 304a is 40 hours whereas the second execution time 304b is 35 hours, the second execution time 304b can be lower than the first execution time 304a. Accordingly, the task scheduler 114 (e.g., using the trained machine-learning model or otherwise) can identify the lower execution time or lowest execution time of the set of execution times 302 as the minimum execution time 306. In certain aspects, the resource constraint 118 with respect to performing the task 106 can be a time-based constraint 308, such as a deadline or timeframe for executing the task 106 or the request 108. If the resource constraint 118 is a time-based constraint 308, the task scheduler 114 can ensure that the minimum execution time 306 is within the time-based constraint 308. After the task scheduler 114 identifies the minimum execution time 306, the task scheduler 114 can determine that the target entity 104 corresponds to the minimum execution time 306. For example, the task scheduler 114 can confirm that the minimum execution time 306 of 35 hours corresponds to the second entity 112b. Based on determining that the target entity 104 corresponds to the minimum execution time 306, the task scheduler 114 can select the target entity 104 for use in performing the task 106.

In some examples, the task scheduler 114 may determine that some or all of the entities 112a-n may be unable to perform the task 106 within the resource constraint 118 provided in the input data 120. For example, the resource constraint 118 can be a time-based constraint 308 of 30 hours, whereas the first execution time 304a and the second execution time 304b is 40 hours and 35 hours, respectively. Accordingly, the respective execution time of each entity of the entities 112a-n can be longer than the resource constraint 118. The task scheduler 114 can use the set of execution times 302 to determine that none of the execution times 304a-b is within the time-based constraint 308. In some cases, the task scheduler 114 may use the trained machine-learning model 102 to make the determination whether some or all of the entities 112a-n are unable to perform the task 106 within the resource constraint 118.

As described above, the task scheduler 114 (e.g., using the trained machine-learning model 102 or otherwise) can determine that entities 112a-n are unable to individually perform the task 106 within the resource constraint 118. Subsequently, the task scheduler 114 can apply the trained machine-learning model 102 to determine a set of target entities 310 capable of collectively performing the task 106 within the resource constraint 118. The set of target entities 310 can include the target entity 104 and at least one other entity. For example, the trained machine-learning model 102 can determine that the first entity 112a and the second entity 112b can cooperate to collectively perform the task 106 within the resource constraint 118. In some examples, the trained machine-learning model 102 can select the set of target entities 310 based on one or more execution outcomes of the entities 112a-n. For example, the trained machine-learning model 102 can use techniques described above with respect to determining the target entity 104 of FIG. 1 to assess the execution outcomes of the entities 112a-n as individuals. Additionally or alternatively, the trained machine-learning model may determine the execution outcomes of the entities 112a-n by evaluating the execution outcomes of the entities 112a-n based on one or more subgroups. Each subgroup associated with the entities 112a-n can include more than one entity such that the trained machine-learning model 102 can determine the execution outcomes of the entities 112a-n when collectively contributing to the task 106.

Once the trained machine-learning model 102 determines the set of target entities 310, the task scheduler 114 of the system 100 can schedule the task 106 to be performed by the set of target entities 310. For example, the task scheduler 114 can schedule the task 106 by tagging each entity of the set of target entities 310 with the task 106. Additionally or alternatively, the task scheduler 114 can schedule the task 106 by adding the task 106 to a respective queue of each entity of the set of target entities 310.

As described above, the trained machine-learning model 102 can use the input data 120 to generate a first output 116a to indicate the set of target entities 310 to perform the first task 106a of the request 108. In some examples, the task scheduler 114 may apply the trained machine-learning model 102 to select the set of target entities 310 to collectively perform multiple tasks of the request 108. For example, the request 108 may include a second task 106b in addition to the first task 106a. If the request 108 includes multiple tasks, the task scheduler 114 can obtain or receive a set of input data 312 corresponding to the tasks 106a-b of the request 108. For example, the set of input data 312 can include the resource constraint 118 provided in the input data 120a with respect to performing the request 108. In some cases, the resource constraint 118 can affect the first task 106a and the second task 106b. Accordingly, the trained machine-learning model 102 can account for the resource constraint 118 with respect to both of the tasks 106a-b when selecting the set of target entities 310.

Based on the set of input data 312, the trained machine-learning model 102 can generate a second output 116b that can include the set of target entities 310 to perform the first task 106a and the second task 106b of the request 108. For example, rather than indicating a single target entity like the first output 116a, the second output 116b of the trained machine-learning model 102 can indicate the set of target entities 310 selected to collectively perform the tasks 106a-b of the request 108. In some examples, the second output 116b can indicate a division of work between entities selected to be part of the set of target entities 310. For example, the second output 116b may indicate which entities should perform the first task 106a as well as which respective portion of the first task 106a is to be performed by each entity. For instance, if a first entity can perform a first portion of the first task 106a faster than a second entity, the first portion of the first task 106a may be assigned to the first entity and a second portion of the first task 106a may be assigned to the second entity. Each entity of the set of target entities 310 can at least partially perform at least one task of the tasks 106a-b.

In some examples, a quantity of entities in the set of target entities 310 may be greater than an amount of tasks associated with the request 108. For example, the set of target entities 310 may include five entities selected to perform three tasks of the request 108. Accordingly, the five entities can collaborate to perform the three tasks of the request 108 such that more than one entity contributes to each task of the request 108, for example by performing a portion (e.g., a subtask) of a particular task of the request 108. In other examples, the quantity of entities in the set of target entities 310 can be less than the amount of tasks of the request 108. As a result, each entity of the set of target entities 310 may perform more than one task of the request 108.

In some implementations, in addition to the set of target entities 310, the second output 116b can include a request execution time 314 corresponding to an amount of time for the set of target entities 310 to perform the request 108. The trained machine-learning model 102 can determine the request execution time 314 of the request 108 based on the set of target entities 310 selected to perform the tasks 106a-b of the request 108. For example, the trained machine-learning model 102 can determine an individual execution time of each entity that is part of the set of target entities 310 with respect to performing the tasks 106a-b that the set of target entities 310 are selected to perform. As an example, if a particular entity is selected as part of the set of target entities 310 to assist with two tasks, the individual execution time of the particular entity can indicate an amount of time to be taken by the particular entity to perform its portion of the two tasks. The request execution time 314 can be within the resource constraint 118 provided in the input data 120 such that the set of target entities 310 are able to perform the request 108 within the resource constraint 118.

In some examples, the task scheduler 114 can obtain or receive updated input data 315 that can include an additional constraint 316 associated with the tasks 106a-b of the request 108. The task scheduler 114 may receive the updated input data 315 after the trained machine-learning model 102 determines the target entity 104 or the set of target entities 310. The additional constraint 316 can preclude a particular entity of the set of target entities 310 from performing a particular task of the tasks 106a-b of the request 108. For example, the first entity 112a may be unavailable (e.g., for maintenance or repair) during a predefined time window. If the additional constraint 316 involves performing the tasks 106a-b of the request 108 within the predefined time window, the additional constraint 316 can preclude the first entity 112a from performing the tasks 106a-b. Accordingly, the task scheduler 114 can provide the updated input data 315 to the trained machine-learning model 102 to generate an updated set of target entities 317 selected to perform the tasks 106a-b based on the updated input data 315. In some cases, the trained machine-learning model 102 can select the updated set of target entities 317 to perform the tasks 106a-b within the request execution time 314 associated with the set of target entities 310 and the additional constraint 316.

The updated set of target entities 317 outputted by the trained machine-learning model 102 can exclude the particular entity precluded by the additional constraint 316. Additionally, the updated set of target entities 317 can include at least one different entity than the set of target entities 310. For instance, when generating the updated set of target entities 317, the trained machine-learning model 102 can determine that the respective execution times of the second entity 112b and a third entity 112c of the entities 112a-n are similar. As a result, the trained machine-learning model 102 can select the third entity 112c to replace the second entity 112b in the updated set of target entities 317. Once the trained machine-learning model 102 generates the updated set of target entities 317, the task scheduler 114 can schedule the tasks 106a-b to be performed by the updated set of target entities 317. In some cases, the task scheduler 114 may update the scheduling of the tasks 106a-b of the request 108 based on the updated set of target entities 317. For example, if the task scheduler 114 has already added the first task 106a to a first queue of the second entity 112b, the task scheduler 114 may remove the first task 106a from the first queue to a second queue corresponding to the third entity 112c.

As an illustrative example, the entities 112a-n may be developers or other suitable personnel that can perform the tasks 106a-b of the request 108. Examples of the tasks 106a-b performed by the entities 112a-n can include building software applications, debugging code, mitigating vulnerabilities, etc. The entities 112a-n may be inaccurate when predicting an amount of time needed to execute the tasks 106a-b of the request 108. Accordingly, the task scheduler 114 can use the trained machine-learning model 102 to determine the set of execution times 302 that includes a respective amount of time taken by each entity to perform the tasks 106a-b. Based on the set of execution times 302, the task scheduler 114 can determine how to schedule the tasks 106a-b of the request 108, for example whether to schedule the tasks 106a-b to be performed by one target entity or multiple target entities. Additionally or alternatively, based on the set of execution times 302, the task scheduler 114 can monitor a progress of the target entity 104 or the set of target entities 310 with respect to performing the tasks 106a-b. For example, the task scheduler 114 may output a warning if the task scheduler 114 determines that a current progress of a particular target entity is insufficient to perform the tasks 106a-b within the resource constraint 118.

Although FIGS. 1-3 depicts a certain number and arrangement of components, this is for illustrative purposes and is intended to be non-limiting. Other examples may include more components, fewer components, different components, or a different arrangement of the components shown in FIGS. 1-3. For example, the task scheduler 114 of FIG. 1 can schedule tasks of more than one request of the system 100.

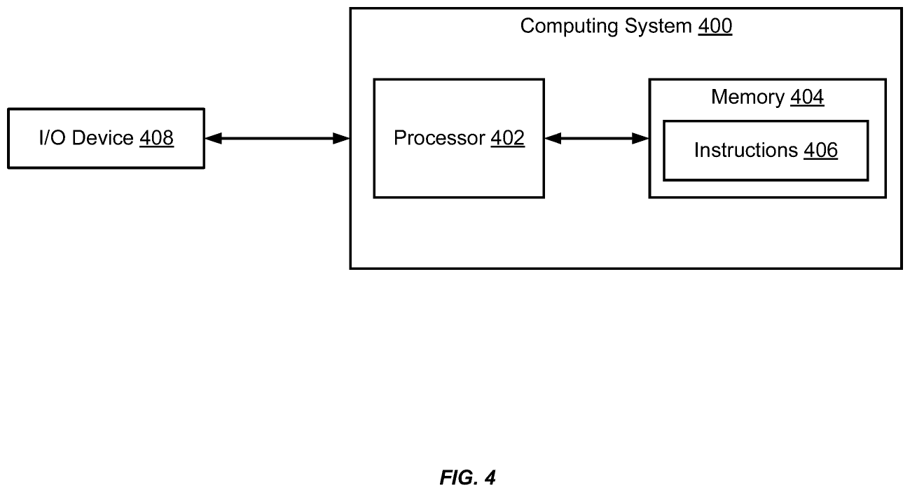

FIG. 4 is a block diagram of an example of a computing system 400 according to some aspects of the present disclosure. The computing system 400 includes a processor 402 that is communicatively coupled to a memory 404. In some examples, the processor 402 and the memory 404 may be distributed from (e.g., remote to) one another. The computing system 400 may be configured to perform any of the techniques described above. Additionally, the computing system 400 can correspond to the system 100 described above with respect to FIG. 1.

The processor 402 can include one processing device or multiple processing devices. Non-limiting examples of the processor 402 include a Field-Programmable Gate Array (FPGA), an application-specific integrated circuit (ASIC), a microprocessor, etc. The processor 402 can execute instructions 406 stored in the memory 404 to perform operations. In some examples, the instructions 406 can include processor-specific instructions generated by a compiler or an interpreter from code written in a suitable computer-programming language, such as C, C++, C#, etc.

The memory 404 can include one memory or multiple memory devices. The memory 404 can be non-volatile and may include any type of memory that retains stored information when powered off. Non-limiting examples of the memory 404 include electrically erasable and programmable read-only memory (EEPROM), flash memory, or any other type of non-volatile memory. At least some of the memory 404 can include a non-transitory computer-readable medium from which the processor 402 can read instructions 406. A computer-readable medium can include electronic, optical, magnetic, or other storage devices capable of providing the processor 402 with computer-readable instructions or other program codes. Non-limiting examples of a computer-readable medium include magnetic disk(s), memory chip(s), ROM, random-access memory (RAM), an ASIC, a configured processor, optical storage, or any other medium from which a computer processor can read the instructions 406.

The computing system 400 additionally may include one or more input/output (I/O) components. For example, the computing system 400 can include an I/O device 408 communicatively coupled to the computing system 400. Additionally or alternatively, the computing system 400 can include other I/O components that are not shown for simplicity. Examples of such input components can include a mouse, a keyboard, a trackball, a touch pad, and a touch-screen display. Examples of such output components can include a visual display or an audio display. Examples of the visual display can include a liquid crystal display (LCD), a light-emitting diode (LED) display, or the touch-screen display. An example of the audio display can include speakers. In some cases, the I/O components can be integrated into a single structure that can be communicatively coupled to the computing system 400. For example, the I/O components may be positioned within the I/O device 408. In other examples, the I/O components can be distributed (e.g., in separate housings) and in electrical communication with each other and the computing system 400.

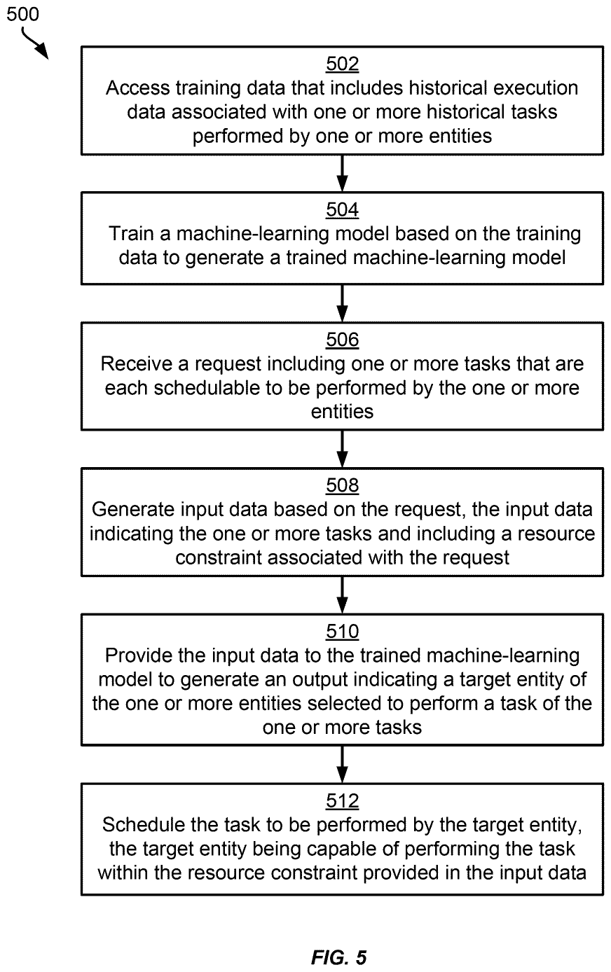

FIG. 5 is a flow chart of an example of a process 500 for providing input data 120 including a resource constraint 118 to a trained machine-learning model 102 to schedule a task 106 to be performed by a target entity 104, according to some aspects of the present disclosure, according to some aspects of the present disclosure. Other examples can involve more operations, fewer operations, different operations, or a different order of operations shown in the figures. The operations of FIG. 5 are described below with reference to the components described above in FIGS. 1-4. Some or all of the steps of the process 500 can be performed by the processor 402.

At block 502, the processor 402 accesses training data 204 that includes historical execution data 206 associated with one or more historical tasks 208a-b performed by one or more entities 112a-n. Certain attributes associated with performing the historical tasks 208a-b can be observed or inferred using the historical execution data 206. For example, the historical execution data 206 can include historical execution times 209 of the entities 112a-n with respect to time taken to perform the historical tasks 208a-b. As another example, the historical execution data 206 can indicate whether the historical tasks 208a-b were executed within certain historical resource constraints, such as storage constraints, processing power constraints, etc. In some examples, the processor 402 can access a database or a data repository storing the training data 204 to obtain the training data 204 used to train a machine-learning model 202.

At block 504, the processor 402 trains the machine-learning model 202 based on the training data 204 to generate a trained machine-learning model 102. Through training, the processor 402 can transform the machine-learning model 202 from an untrained state to a trained state corresponding to the trained machine-learning model 102. The processor 402 can iteratively provide the training data 204 to the machine-learning model 202 to enable the machine-learning model 202 to identify trends or relationships of the training data 204. The processor 402 can train the machine-learning model 202 in a supervised manner, an unsupervised manner, or a semi-supervised manner. Additionally, training the machine-learning model 202 can involve adjusting one or more parameters of the machine-learning model 202 to minimize a loss function 218 of the machine-learning model 202. In some examples, the processor 402 can train the machine-learning model 202 using a model training application 200.

At block 506, the processor 402 receives a request 108 including one or more tasks 106a-b that are each schedulable to be performed by the one or more entities 112a-n. For example, the request 108 can be generated and transmitted to the processor 402 in response to input provided by a user of a computing system (e.g., the computing system 400), such as via an input/output (I/O) device 408. In some cases, the user of the computing system may define the tasks 106a-b of the request 108. In other cases, the processor 402 may determine the tasks 106a-b based on the request 108.

At block 508, the processor 402 generates input data 120 based on the request 108. The input data 120 can indicate the tasks 106a-b and include a resource constraint 118 associated with the request 108. In some examples, the resource constraint 118 can be a time-based constraint 308, such as with respect to response times or data transmission times. The processor 402 can execute the trained machine-learning model 102 to generate an output 116 that the processor 402 can use to schedule the tasks 106a-b to be executed within the resource constraint 118.

At block 510, the processor 402 provides the input data 120 to the trained machine-learning model 102 to generate the output 116 indicating a target entity 104 of the entities 112a-n selected to perform a particular task of the tasks 106a-b. In some examples, based on the input data 120, the trained machine-learning model 102 can determine a set of execution times 302 that includes a respective execution time corresponding to each entity of the entities 112a-n. After determining the set of execution times 302, the trained machine-learning model 102 or another component of the task scheduler 114 can determine a minimum execution time 306 of the set of execution times 302. The trained machine-learning model 102 or another component of the task scheduler 114 can then select a particular entity corresponding to the minimum execution time 306 as the target entity 104.

At block 512, the processor 402 schedules the task 106 to be performed by the target entity 104. The target entity 104 can be capable of performing the task 106 within the resource constraint 118 provided in the input data 120. For example, if the resource constraint 118 corresponds to response time of the request 108, the target entity 104 can execute the task 106 within a predefined amount of time to ensure that the request 108 is executed within the resource constraint 118. In some examples, the processor 402 can schedule the task 106 to be performed by the target entity 104 by tagging the target entity 104 with the task 106. Additionally or alternatively, the processor 402 may schedule the task 106 by adding the task 106 to a queue of the target entity 104.

The task scheduling techniques described herein can improve resource allocation of system resources by enabling efficient allocation of tasks while ensuring that the tasks can be performed within a resource constraint. For example, a task scheduler of a computing system can receive a request related to a computing job that involves executing one or more tasks to mitigate a vulnerability (e.g., bugs, exploits, unpatched code, etc.) of the computing system. The task scheduler can allocate the tasks to one or more workers associated with the computing system. The request may be submitted by a user. Based on the request, the task scheduler can generate input data to provide to a trained neural network. The input data may include a time-based constraint, such as target deployment date by which a software patch should be deployed to mitigate the vulnerability in a timely manner. In response to receiving the input data, the trained neural network can determine a set of target workers to assign the tasks and generate an output indicating the set of target workers. The set of target workers may be assigned to execute their respective tasks concurrently or sequentially to one another. The trained neural network can be trained using historical performance data of the workers to determine a respective capacity or a respective execution time of each worker. The historical performance data can indicate historical execution times taken by the workers to execute historical tasks. Additionally, the historical performance data may indicate other metrics of the workers with respect to executing the historical tasks, such as a respective amount of system resources consumed by each worker to perform a certain task. Accordingly, the trained neural network can decide how to allocate the tasks to ensure that the set of target workers has sufficient system resources to execute the tasks. Once the trained neural network assigns the tasks to the set of target workers, the task scheduler can use the assignments to add the tasks to a respective queue of each target worker that is part of the set of target workers. Thus, the task scheduler can schedule the tasks of the computing job to be performed by the set of target workers, ensuring that the computing job can be executed by the target deployment date with efficient allocation of the system resources.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
one or more processors; and
one or more memory devices including instructions that are executable by the one or more processors for causing the one or more processors to perform operations comprising:
accessing training data that includes historical execution data associated with one or more historical tasks performed by one or more entities, the historical execution data indicating one or more relationships between the one or more entities and one or more historical execution outcomes of the one or more historical tasks;
training a machine-learning model based on the training data to generate a trained machine-learning model, wherein training the machine-learning model involves performing iterative adjustments of parameters of the machine-learning model to minimize a loss function associated with the machine-learning model;
receiving a request comprising one or more tasks that are each schedulable to be performed by the one or more entities;
generating input data based on the request, the input data indicating the one or more tasks and including a resource constraint related to completing the one or more tasks;
providing the input data to the trained machine-learning model configured to generate an output indicating a respective execution outcome corresponding to each entity of the one or more entities with respect to performing at least one task of the one or more tasks;
determining, based on the output of the trained machine-learning model, that the one or more entities are unable to individually perform at least one task of the one or more tasks within the resource constraint; and
performing an action to resolve the inability of the one or more entities to individually perform the at least one task within the resource constraint.

2. The system of claim 1, wherein the operations further comprise, subsequent to providing the input data to the trained machine-learning model:
determining, based on the input data, a respective entity identifier associated with each entity of the one or more entities, wherein the respective entity identifier is used by the trained machine-learning model to identify the one or more entities prior to determining the respective execution outcome for each of the one or more entities with respect to performing the one or more tasks; and
generating, by the trained machine-learning model based on the input data, a set of execution times comprising a respective execution time for each entity of the one or more entities to perform the one or more tasks, wherein the respective execution time corresponds to the respective execution outcome of the one or more entities.

3. The system of claim 2, wherein training the machine-learning model further comprises:
identifying, using the respective entity identifier associated with each entity, respective historical execution data corresponding to a respective subset of the one or more historical tasks performed by each entity, wherein the respective historical execution data includes historical execution times used by each entity to perform the one or more historical tasks; and
providing the historical execution times of the respective historical execution data as part of the one or more historical execution outcomes included in the training data used to train the machine-learning model.

4. The system of claim 1, wherein the resource constraint comprises a time-based constraint to perform the one or more tasks.

5. The system of claim 1, wherein performing the action comprises:
identifying one or more incomplete tasks to be performed by the one or more entities; and
rescheduling the one or more incomplete tasks based on a respective priority of the one or more incomplete tasks and the one or more tasks of the request, wherein at least one task of the one or more tasks is configured to be performed prior to performing the one or more incomplete tasks.

6. The system of claim 1, wherein the operations further comprise:
determining that each execution outcome of the one or more entities exceeds the resource constraint such that the one or more entities are unable to individually perform the one or more tasks within the resource constraint provided in the input data;
executing the trained machine-learning model to determine a set of target entities capable of collectively performing the one or more tasks within the resource constraint; and
scheduling the one or more tasks to be performed by the set of target entities by tagging each entity of the set of target entities with at least one task of the one or more tasks.

7. The system of claim 1, wherein the operations further comprise:
generating updated training data by updating the training data using information collected from one or more logs; and
retraining the trained machine-learning model using the updated training data to modify the parameters of the trained machine-learning model.

8. A computer-implemented method comprising:
accessing training data that includes historical execution data associated with one or more historical tasks performed by one or more entities, the historical execution data indicating one or more relationships between the one or more entities and one or more historical execution outcomes of the one or more historical tasks;
training a machine-learning model based on the training data to generate a trained machine-learning model, wherein training the machine-learning model involves performing iterative adjustments of parameters of the machine-learning model to minimize a loss function associated with the machine-learning model;
receiving a request comprising one or more tasks that are each schedulable to be performed by the one or more entities;
generating input data based on the request, the input data indicating the one or more tasks and including a resource constraint related to completing the one or more tasks;
providing the input data to the trained machine-learning model configured to generate an output indicating a respective execution outcome corresponding to each entity of the one or more entities with respect to performing at least one task of the one or more tasks;
determining, based on the output of the trained machine-learning model, that the one or more entities are unable to individually perform at least one task of the one or more tasks within the resource constraint; and
performing an action to resolve the inability of the one or more entities to individually perform the at least one task within the resource constraint.

9. The computer-implemented method of claim 8, further comprising, subsequent to providing the input data to the trained machine-learning model:
determining, based on the input data, a respective entity identifier associated with each entity of the one or more entities, wherein the respective entity identifier is used by the trained machine-learning model to identify the one or more entities prior to determining the respective execution outcome for each of the one or more entities with respect to performing the one or more tasks; and
generating, by the trained machine-learning model based on the input data, a set of execution times comprising a respective execution time for each entity of the one or more entities to perform the one or more tasks, wherein the respective execution time corresponds to the respective execution outcome of the one or more entities.

10. The computer-implemented method of claim 9, wherein training the machine-learning model further comprises:
identifying, using the respective entity identifier associated with each entity, respective historical execution data corresponding to a respective subset of the one or more historical tasks performed by each entity, wherein the respective historical execution data includes historical execution times used by each entity to perform the one or more historical tasks; and
providing the historical execution times of the respective historical execution data as part of the one or more historical execution outcomes included in the training data used to train the machine-learning model.

11. The computer-implemented method of claim 8, wherein the resource constraint comprises a time-based constraint to perform the task.

12. The computer-implemented method of claim 8, wherein performing the action comprises:
identifying one or more incomplete tasks to be performed by the one or more entities; and
rescheduling the one or more incomplete tasks based on a respective priority of the one or more incomplete tasks and the one or more tasks of the request, wherein at least one task of the one or more tasks is configured to be performed prior to performing the one or more incomplete tasks.

13. The computer-implemented method of claim 8, further comprising:
determining that each execution outcome of the one or more entities exceeds the resource constraint such that the one or more entities are unable to individually perform the one or more tasks within the resource constraint provided in the input data;
executing the trained machine-learning model to determine a set of target entities capable of collectively performing the one or more tasks within the resource constraint; and
scheduling the one or more tasks to be performed by the set of target entities by tagging each entity of the set of target entities with at least one task of the one or more tasks.

14. The computer-implemented method of claim 8, further comprising:
generating updated training data by updating the training data using information collected from one or more logs; and
retraining the trained machine-learning model using the updated training data to modify the parameters of the trained machine-learning model.

15. A non-transitory computer-readable medium comprising program code that is executable by one or more processors for causing the one or more processors to:
access training data that includes historical execution data associated with one or more historical tasks performed by one or more entities, the historical execution data indicating one or more relationships between the one or more entities and one or more historical execution outcomes of the one or more historical tasks;
train a machine-learning model based on the training data to generate a trained machine-learning model, wherein training the machine-learning model involves performing iterative adjustments of parameters of the machine-learning model to minimize a loss function associated with the machine-learning model;
receive a request comprising one or more tasks that are each schedulable to be performed by the one or more entities;
generate input data based on the request, the input data indicating the one or more tasks and including a resource constraint related to completing the one or more tasks;
provide the input data to the trained machine-learning model configured to generate an output indicating a respective execution outcome corresponding to each entity of the one or more entities with respect to performing at least one task of the one or more tasks;
determine, based on the output of the trained machine-learning model, that the one or more entities are unable to individually perform at least one task of the one or more tasks within the resource constraint; and
perform an action to resolve the inability of the one or more entities to individually perform the at least one task within the resource constraint.

16. The non-transitory computer-readable medium of claim 15, further comprising program code that is executable by the one or more processors for causing the one or more processors to, subsequent to providing the input data to the trained machine-learning model:
determine, based on the input data, a respective entity identifier associated with each entity of the one or more entities, wherein the respective entity identifier is used by the trained machine-learning model to identify the one or more entities prior to determining the respective execution outcome for each of the one or more entities with respect to performing the one or more tasks; and
generate, by the trained machine-learning model based on the input data, a set of execution times comprising a respective execution time for each entity of the one or more entities to perform the one or more tasks, wherein the respective execution time corresponds to the respective execution outcome of the one or more entities.

17. The non-transitory computer-readable medium of claim 16, wherein training the machine-learning model further comprises:
identifying, using the respective entity identifier associated with each entity, respective historical execution data corresponding to a respective subset of the one or more historical tasks performed by each entity, wherein the respective historical execution data includes historical execution times used by each entity to perform the one or more historical tasks; and
providing the historical execution times of the respective historical execution data as part of the one or more historical execution outcomes included in the training data used to train the machine-learning model.

18. The non-transitory computer-readable medium of claim 15, wherein the resource constraint comprises a time-based constraint to perform the one or more tasks.

19. The non-transitory computer-readable medium of claim 15, wherein performing the action comprises:
identifying one or more incomplete tasks to be performed by the one or more entities; and
rescheduling the one or more incomplete tasks based on a respective priority of the one or more incomplete tasks and the one or more tasks of the request, wherein at least one task of the one or more tasks is configured to be performed prior to performing the one or more incomplete tasks.

20. The non-transitory computer-readable medium of claim 17, further comprising program code that is executable by the one or more processors for causing the one or more processors to:
determine that each execution outcome of the one or more entities exceeds the resource constraint such that the one or more entities are unable to individually perform the one or more tasks within the resource constraint provided in the input data;
execute the trained machine-learning model to determine a set of target entities capable of collectively performing the one or more tasks within the resource constraint; and
schedule the one or more tasks to be performed by the set of target entities by tagging each entity of the set of target entities with at least one task of the one or more tasks.
